(19) United States
(12) Patent Application Publication
(10) Pub. No.: US 2026/0269732 A1
(43) Pub. Date: Sep. 10, 2026

(54) POWER CONVERSION CIRCUIT AND OPERATION METHOD THEREOF

(71) Applicant: LITE-ON TECHNOLOGY CORPORATION, TAIPEI CITY (TW)

(72) Inventor: Zhong-Heng LI, Taipei City (TW)

(21) Appl. No.: 19/246,953

(22) Filed: Jun. 24, 2025

(30) Foreign Application Priority Data
Mar. 4, 2025 (CN) 202510248274.0

(51) Int. Cl. H02M 3/335; H02M 1/00; H02M 1/14; H02M 3/00

(52) U.S. Cl. CPC H02M 3/33573; H02M 1/0043; H02M 1/14; H02M 3/01

(57) ABSTRACT

A power conversion circuit includes a first resonant converter, a second resonant converter and a control device. The control device provides first and second switching signals to the first and second resonant converters. The control device includes first, second, and third control modules. The first control module determines a switching frequency corresponding to the first and second switching signals according to an output voltage, a total output current, a predetermined voltage and a predetermined current. The second control module determines a phase shift angle corresponding to the first and second switching signals according to first and second currents of the first and second resonant converters. The third control module generates the first and second switching signals according to the switching frequency and the phase shift angle, and controls an interleaved phase angle between the first and second switching signals according to the switching frequency and a resonant frequency.

### CROSS REFERENCE TO RELATED APPLICATIONS

This application claims priority of China Patent Application No. 202510248274.0, filed on Mar. 4, 2025, the entirety of which is incorporated by reference herein.

### BACKGROUND OF THE DISCLOSURE

### Field of the Disclosure

An embodiment of the disclosure relates to a power conversion circuit, and in particular it relates to a power conversion circuit and an operation method thereof.

### Description of the Related Art

Generally speaking, LLC architecture may meet the needs of high-power and high-efficiency applications. However, in high-current applications, when the secondary side operates in discontinuous current mode (DCM), the current ripple may be larger, requiring that a capacitor with sufficient rating be connected in parallel. Therefore, a new design is needed to solve the problem described above.

### BRIEF SUMMARY OF THE DISCLOSURE

An embodiment of the disclosure provides a power conversion circuit and an operation method thereof, so that the current of the power conversion circuit is balanced, and the current ripple of the power conversion circuit is reduced, thereby reducing the number of input and output capacitors.

An embodiment of the disclosure provides a power conversion circuit, which includes a first resonant converter, a second resonant converter and a control device. The first resonant converter includes a first transformer, a first resonant inductor, a first resonant capacitor, a first bridge switching circuit and a first rectifier circuit. The first transformer includes a first primary winding and a first secondary winding. The first resonant inductor and the first resonant capacitor are connected in series and connected to the first primary winding. The first bridge switching circuit is connected to the first resonant inductor, the first resonant capacitor and the first primary winding. The first secondary winding is connected to the first rectifier circuit. The second resonant converter includes a second transformer, a second resonant inductor, a second resonant capacitor, a second bridge switching circuit and a second rectifier circuit. The second transformer includes a second primary winding and a second secondary winding. The second resonant inductor and the second resonant capacitor are connected in series and connected to the second primary winding. The second bridge switching circuit is connected to the second resonant inductor, the second resonant capacitor and the second primary winding. The second secondary winding is connected to the second rectifier circuit. The first bridge switching circuit and the second bridge switching circuit receive an input voltage. An output terminal of the first rectifier circuit and an output terminal of the second rectifier circuit are connected in parallel. The first rectifier circuit and the second rectifier circuit output an output voltage. The control device is configured to provide a plurality of first switching signals to the first bridge switching circuit and provide a plurality of second switching signals to the second bridge switching circuit. The control device includes a first control module, a second control module and a third control module. The first control module is configured to determine a switching frequency corresponding to the first switching signals and the second switching signals according to the output voltage, a total output current, a predetermined voltage and a predetermined current. The second control module is configured to determine a phase shift angle corresponding to the first switching signals and the second switching signals according to a first current flowing through the first resonant inductor and a second current flowing through the second resonant inductor. The third control module is configured to generate the first switching signals and the second switching signals according to the switching frequency and the phase shift angle, and to control the interleaved phase angle between the first switching signals and the second switching signals according to the switching frequency and a resonant frequency.

An embodiment of the disclosure provides an operation method of a power conversion circuit. The power conversion circuit includes a first resonant converter and a second resonant converter. The first resonant converter includes a first transformer, a first resonant inductor, a first resonant capacitor, a first bridge switching circuit and a first rectifier circuit. The first transformer includes a first primary winding and a first secondary winding. The first resonant inductor and the first resonant capacitor are connected in series and connected to the first primary winding. The first bridge switching circuit is connected to the first resonant inductor, the first resonant capacitor and the first primary winding. The first secondary winding is connected to the first rectifier circuit. The second resonant converter includes a second transformer, a second resonant inductor, a second resonant capacitor, a second bridge switching circuit and a second rectifier circuit. The second transformer includes a second primary winding and a second secondary winding. The second resonant inductor and the second resonant capacitor are connected in series and connected to the second primary winding. The second bridge switching circuit is connected to the second resonant inductor, the second resonant capacitor and the second primary winding. The second secondary winding is connected to the second rectifier circuit. The first bridge switching circuit and the second bridge switching circuit receive an input voltage. An output terminal of the first rectifier circuit and an output terminal of the second rectifier circuit are connected in parallel. The first rectifier circuit and the second rectifier circuit output an output voltage. The above operation method includes the following steps. A first control module is used to receive the output voltage and a total output current, and determine a switching frequency corresponding to the power conversion circuit according to the output voltage, the total output current, a predetermined voltage and a predetermined current. A second control module is used to receive a first current flowing through the first resonant inductor and a second current flowing through the second resonant inductor, and determine a phase shift angle corresponding to the power conversion circuit according to the first current and the second current. A third control module is used to generate a plurality of first switching signals and a plurality of second switching signals according to the switching frequency and the phase shift angle. The third control module is used to control the interleaved phase angle between the first switching signals and the second switching signals according to the switching frequency and a resonant frequency.

According to the power conversion circuit and the operation method thereof disclosed by the embodiment of the disclosure, the first control module receives the output voltage and the total output current, and determines the switching frequency corresponding to the power conversion circuit according to the output voltage, the total output current, the predetermined voltage and the predetermined current. The second control module determines the phase shift angle corresponding to the power conversion circuit according to the first current flowing through the first resonant inductor and the second current flowing through the second resonant inductor. The third control module generates the first switching signals and the second switching signals according to the switching frequency and the phase shift angle, and controls the interleaved phase angle between the first switching signals and the second switching signals according to the switching frequency and the resonant frequency. Therefore, the current of the power conversion circuit may be effectively balanced, and current ripple may be reduced, thereby reducing the number of input and output capacitors.

### BRIEF DESCRIPTION OF THE DRAWINGS

The disclosure can be more fully understood by reading the subsequent detailed description and examples with references made to the accompanying drawings, wherein:

FIG. 1 is a schematic view of a power conversion circuit according to an embodiment of the disclosure;

FIG. 2 is a detailed schematic view of a power conversion circuit according to an embodiment of the disclosure;

FIG. 3 is a schematic view of a control device according to an embodiment of the disclosure;

FIG. 4 is a waveform diagram of a current ICout, a current I_P1, a current I_P2, a switching signal CS1_P1, a switching signal CS4_P1, a switching signal CS1_P2 and a switching signal CS4_P2 when a switching frequency is greater than or equal to a resonant frequency according to an embodiment of the disclosure;

FIG. 5 is a waveform diagram of a current ICout, a current I_P1, a current I_P2, a switching signal CS1_P1, a switching signal CS4_P1, a switching signal CS1_P2 and a switching signal CS4_P2 when a switching frequency is less than a resonant frequency according to an embodiment of the disclosure;

FIG. 6 is a flowchart of an operation method of a power conversion circuit according to an embodiment of the disclosure;

FIG. 7 is a detailed flowchart of step S602 in FIG. 6; and

FIG. 8 is a detailed flowchart of step S608 in FIG. 6.

### DETAILED DESCRIPTION OF THE EXEMPLARY EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, a person skilled in the art would selectively implement all or some technical features of any embodiment of the disclosure or selectively combine all or some technical features of the embodiments of the disclosure.

In each of the following embodiments, the same reference number represents the same or similar element or component.

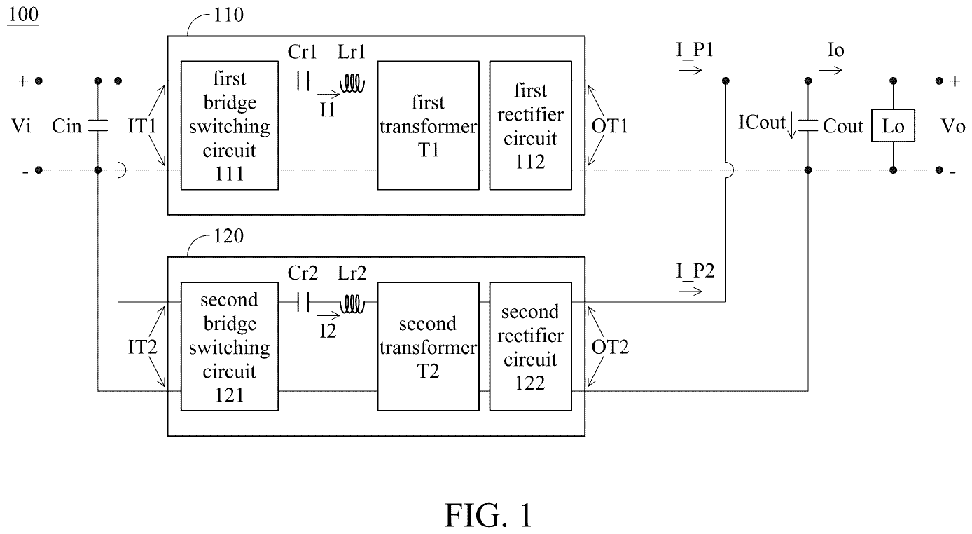

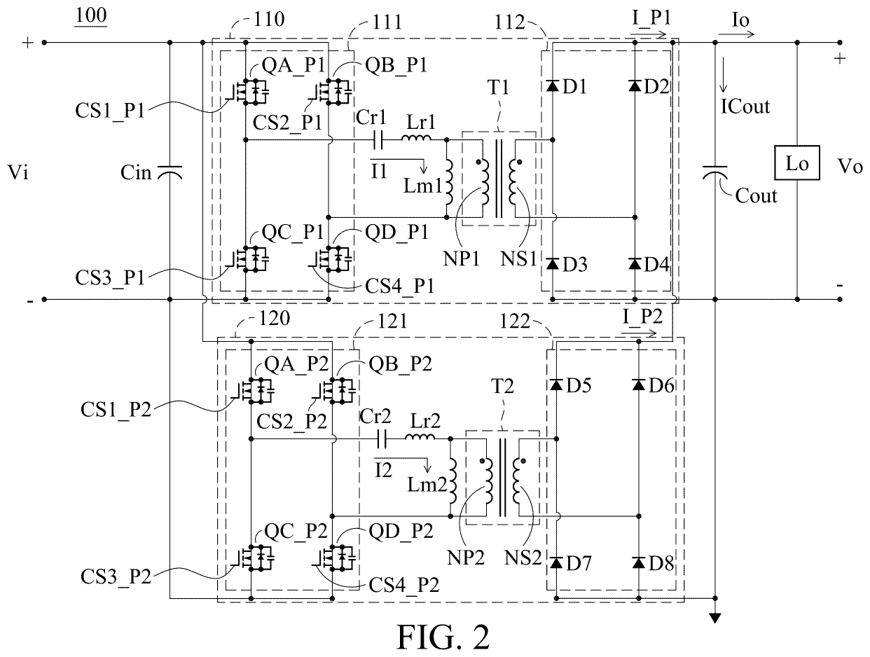

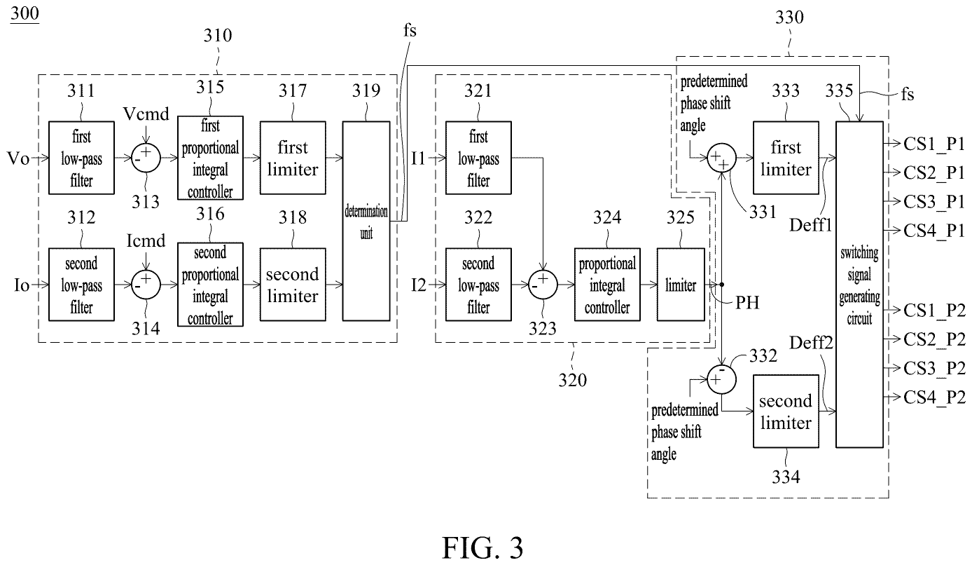

FIG. 1 is a schematic view of a power conversion circuit according to an embodiment of the disclosure. FIG. 2 is a detailed schematic view of a power conversion circuit according to an embodiment of the disclosure. FIG. 3 is a schematic view of a control device according to an embodiment of the disclosure. Please refer to FIG. 1, FIG. 2 and FIG. 3. The power conversion circuit 100 may include a first resonant converter 110, a second resonant converter 120 and a control device 300.

The first resonant converter 110 may receive an input voltage Vi, and output an output voltage Vo. Furthermore, the first resonant converter 110 may include an input terminal IT1 and an output terminal OT1. A positive terminal of the input terminal IT1 of the first resonant converter 110 is coupled to a positive terminal of the input voltage Vi. A negative terminal of the input terminal IT1 of the first resonant converter 110 is coupled to a negative terminal of the input voltage Vi. A positive terminal of the output terminal OT1 of the first resonant converter 110 is coupled to a positive terminal of the output voltage Vo. A negative terminal of the output terminal OT1 of the first resonant converter 110 is coupled to a negative terminal of the output voltage Vo. In addition, the first resonant converter 110 includes a first bridge switching circuit 111, a first resonant capacitor Cr1, a first resonant inductor Lr1, a first transformer T1 and a first rectifier circuit 112. The first bridge switching circuit 111 includes a first terminal, a second terminal, a third terminal and a fourth terminal. The first terminal of the first bridge switching circuit 111 is coupled to the positive terminal of the input terminal IT1 of the first resonant converter 110. The second terminal of the first bridge switching circuit 111 is coupled to the negative of the input terminal IT1 of the first resonant converter 110.

In some embodiments, the first bridge switching circuit 111 may be a full-bridge switching circuit. Furthermore, the first bridge switching circuit 111 may include a switch QA_P1, a switch QB_P1, a switch QC_P1 and a switch QD_P1. The switch QA_P1 includes a first terminal, a second terminal and a control terminal. The first terminal of the switch QA_P1 is coupled to the first terminal of the first bridge switching circuit 111. The second terminal of the switch QA_P1 is coupled to the third terminal of the first bridge switching circuit 111. The control terminal of the switch QA_P1 receives a switching signal CS1_P1. The switch QB_P1 includes a first terminal, a second terminal and a control terminal. The first terminal of the switch QB_P1 is coupled to the first terminal of the switch QA_P1. The second terminal of the switch QB_P1 is coupled to the fourth terminal of the first bridge switching circuit 111. The control terminal of the switch QB_P1 receives a switching signal CS2_P1.

The switch QC_P1 includes a first terminal, a second terminal and a control terminal. The first terminal of the switch QC_P1 is coupled to the second terminal of the switch QA_P1. The second terminal of the switch QC_P1 is coupled to the second terminal of the first bridge switching circuit 111. The control terminal of the switch QC_P1 receives a switching signal CS3_P1. The switch QD_P1 includes a first terminal, a second terminal and a control terminal. The first terminal of the switch QD_P1 is coupled to the second terminal of the switch QB_P1. The second terminal of the switch QD_P1 is coupled to the second terminal of the switch QC_P1. The control terminal of the switch QD_P1 receives a switching signal CS4_P1.

The first resonant capacitor Cr1 includes a first terminal and a second terminal. The first terminal of the first resonant capacitor Cr1 is coupled to the third terminal of the first bridge switching circuit 111 (such as the second terminal of the switch QA_P1). The first resonant inductor Lr1 includes a first terminal and a second terminal. The first terminal of the first resonant inductor Lr1 is coupled to the second terminal of the first resonant capacitor Cr1. That is, the first resonant inductor Lr1 and the first resonant capacitor Cr1 are connected in series. A first current I1 flows through the first resonant inductor Lr1. In some embodiments, the first resonant converter 110 may further include a magnetizing inductor Lm1, as shown in FIG. 2. The magnetizing inductor Lm1 includes a first terminal and a second terminal. The first terminal of the magnetizing inductor Lm1 is coupled to the second terminal of the first resonant inductor Lr1. The second terminal of the magnetizing inductor Lm1 is coupled to the fourth terminal of the first bridge switching circuit 111 (such as the second terminal of the switch QB_P1).

The first transformer T1 includes a first terminal, a second terminal, a third terminal and a fourth terminal. The first terminal of the first transformer T1 is coupled to the second terminal of the first resonant inductor Lr1. The second terminal of the first transformer T1 is coupled to the fourth terminal of the first bridge switching circuit 111 (such as the second terminal of the switch QB_P1). Furthermore, the first transformer T1 may include a first primary winding NP1 and a first secondary winding NS1. The first primary winding NP1 includes a first terminal and a second terminal. The first terminal of the first primary winding NP1 is coupled to the first terminal of the first transformer T1. The second terminal of the first primary winding NP1 is coupled to the second terminal of the first transformer T1. The first secondary winding NS1 includes a first terminal and a second terminal. The first terminal of the first secondary winding NS1 is coupled to the third terminal of the first transformer T1. The second terminal of the first secondary winding NS1 is coupled to the fourth terminal of the first transformer T1.

The first rectifier circuit 112 includes a first terminal, a second terminal, a third terminal and a fourth terminal. The first terminal of the first rectifier circuit 112 is coupled to the third terminal of the first transformer T1. The second terminal of the first rectifier circuit 112 is coupled to the fourth terminal of the first transformer T1. The third terminal of the first rectifier circuit 112 is coupled to the positive terminal of the output terminal OT1 of the first resonant converter 110 and outputs a current I_P1. The fourth terminal of the first rectifier circuit 112 is coupled to the negative terminal of the output terminal OT1 of the first resonant converter 110.

In some embodiments, the first rectifier circuit 112 may be a full-bridge switching circuit. Furthermore, the first rectifier circuit 112 includes a diode D1, a diode D2, a diode D3 and a diode D4. The diode D1 includes an anode terminal and a cathode terminal. The anode terminal of the diode D1 is coupled to the first terminal of the first rectifier circuit 112. The cathode terminal of the diode D1 is coupled to the third terminal of the first rectifier circuit 112. The diode D2 includes an anode terminal and a cathode terminal. The anode terminal of the diode D2 is coupled to the second terminal of the first rectifier circuit 112. The cathode terminal of the diode D2 is coupled to the cathode terminal of the diode D1. The diode D3 includes an anode terminal and a cathode terminal. The anode terminal of the diode D3 is coupled to a ground terminal. The cathode terminal of the diode D3 is coupled to the anode terminal of the diode D1. The diode D4 includes an anode terminal and a cathode terminal. The anode terminal of the diode D4 is coupled to the anode terminal of the diode D3. The cathode terminal of the diode D4 is coupled to the anode terminal of the diode D2. The first rectifier circuit 112 generates and outputs the current I_P1.

The second resonant converter 120 includes an input terminal IT2 and an output terminal OT2. A positive terminal of the input terminal IT2 of the second resonant converter 120 is coupled to a positive terminal of the input terminal IT1 of the first resonant converter 110. A negative terminal of the input terminal IT2 of the second resonant converter 120 is coupled to a negative terminal of the input terminal IT1 of the first resonant converter 110. A positive terminal of the output terminal OT2 of the second resonant converter 120 is coupled to a positive terminal of the output terminal OT1 of the first resonant converter 110. A negative terminal of the output terminal OT2 of the second resonant converter 120 is coupled to a negative terminal of the output terminal OT1 of the first resonant converter 110. That is, the first resonant converter 110 and the second resonant converter 120 are connected in parallel.

In addition, the second resonant converter 120 includes a second bridge switching circuit 121, a second resonant capacitor Cr2, a second resonant inductor Lr2, a second transformer T2 and a second rectifier circuit 122. The second bridge switching circuit 121 includes a first terminal, a second terminal, a third terminal and a fourth terminal. The first terminal of the second bridge switching circuit 121 is coupled to the positive terminal of the input terminal IT2 of the second resonant converter 120. The second terminal of the second bridge switching circuit 121 is coupled to the negative terminal of the input terminal IT2 of the second resonant converter 120.

In some embodiments, the second bridge switching circuit 121 may be a full-bridge switching circuit. Furthermore, the second bridge switching circuit 121 may include a switch QA_P2, a switch QB_P2, a switch QC_P2 and a switch QD_P2. The switch QA_P2 includes a first terminal, a second terminal and a control terminal. The first terminal of the switch QA_P2 is coupled to the first terminal of the second bridge switching circuit 121. The second terminal of the switch QA_P2 is coupled to the third terminal of the second bridge switching circuit 121. The control terminal of the switch QA_P2 receives a switching signal CS1_P2. The switch QB_P2 includes a first terminal, a second terminal and a control terminal. The first terminal of the switch QB_P2 is coupled to the first terminal of the switch QA_P2. The second terminal of the switch QB_P2 is coupled to the fourth terminal of the second bridge switching circuit 121. The control terminal of the switch QB_P2 receives a switching signal CS2_P2.

The switch QC_P2 includes a first terminal, a second terminal and a control terminal. The first terminal of the switch QC_P2 is coupled to the second terminal of the switch QA_P2. The second terminal of the switch QC_P2 is coupled to the second terminal of the second bridge switching circuit 121. The control terminal of the switch QC_P2 receives a switching signal CS3_P2. The switch QD_P2 includes a first terminal, a second terminal and a control terminal. The first terminal of the switch QD_P2 is coupled to the second terminal of the switch QB_P2. The second terminal of the switch QD_P2 is coupled to the second terminal of the switch QC_P2. The control terminal of the switch QD_P2 receives a switching signal CS4_P2.

The second resonant capacitor Cr2 includes a first terminal and a second terminal. The first terminal of the second resonant capacitor Cr2 is coupled to the third terminal of the second bridge switching circuit 121 (such as the second terminal of the switch QA_P2). The second resonant inductor Lr2 includes a first terminal and a second terminal. The first terminal of the second resonant inductor Lr2 is coupled to the second terminal of the second resonant capacitor Cr2. That is, the second resonant inductor Lr2 and the second resonant capacitor Cr2 are connected in series. A second current I2 flows through the second resonant inductor Lr2. In some embodiments, the second resonant converter 120 may further include a magnetizing inductor Lm2, as shown in FIG. 2. The magnetizing inductor Lm2 includes a first terminal and a second terminal. The first terminal of the magnetizing inductor Lm2 is coupled to the second terminal of the second resonant inductor Lr2. The second terminal of the magnetizing inductor Lm2 is coupled to the fourth terminal of the second bridge switching circuit 121 (such as the second terminal of the switch QB_P2).

The second transformer T2 includes a first terminal, a second terminal, a third terminal and a fourth terminal. The first terminal of the second transformer T2 is coupled to the second terminal of the second resonant inductor Lr2. The second terminal of the second transformer T2 is coupled to the fourth terminal of the second bridge switching circuit 121 (such as the second terminal of the switch QB_P2). Furthermore, the second transformer T2 may include a second primary winding NP2 and a second secondary winding NS2. The second primary winding NP2 includes a first terminal and a second terminal. The first terminal of the second primary winding NP2 is coupled to the first terminal of the second transformer T2. The second terminal of the second primary winding NP2 is coupled to the second terminal of the second transformer T2. The second secondary winding NS2 includes a first terminal and a second terminal. The first terminal of the second secondary winding NS2 is coupled to the third terminal of the second transformer T2. The second terminal of the second secondary winding NS2 is coupled to the fourth terminal of the second transformer T2.

The second rectifier circuit 122 includes a first terminal, a second terminal, a third terminal and a fourth terminal. The first terminal of the second rectifier circuit 122 is coupled to the third terminal of the second transformer T2. The second terminal of the second rectifier circuit 122 is coupled to the fourth terminal of the second transformer T2. The third terminal of the second rectifier circuit 122 is coupled to the positive terminal of the output terminal OT2 of the second resonant converter 120 and outputs a current I_P2. The fourth terminal of the second rectifier circuit 122 is coupled to the negative terminal of the output terminal OT2 of the second resonant converter 120. Since the output terminal OT1 of the first resonant converter 110 and the output terminal OT2 of the second resonant converter 120 are connected, the output terminal of the first rectifier circuit 112 and the output terminal of the second rectifier circuit 122 are also connected, and the first rectifier circuit 112 and the second rectifier circuit 122 output the output voltage Vo.

In some embodiments, the second rectifier circuit 122 may be a full-bridge switching circuit. Furthermore, the second rectifier circuit 122 includes a diode D5, a diode D6, a diode D7 and a diode D8. The diode D5 includes an anode terminal and a cathode terminal. The anode terminal of the diode D5 is coupled to the first terminal of the second rectifier circuit 122. The cathode terminal of the diode D5 is coupled to the third terminal of the second rectifier circuit 122. The diode D6 includes an anode terminal and a cathode terminal. The anode terminal of the diode D6 is coupled to the second terminal of the second rectifier circuit 122. The cathode terminal of the diode D6 is coupled to the cathode terminal of the diode D5. The diode D7 includes an anode terminal and a cathode terminal. The anode terminal of the diode D7 is coupled to the ground terminal. The cathode terminal of the diode D7 is coupled to the anode terminal of the diode D5. The diode D8 includes an anode terminal and a cathode terminal. The anode terminal of the diode D8 is coupled to the anode terminal of the diode D7. The cathode terminal of the diode D8 is coupled to the anode terminal of the diode D6. The second rectifier circuit 122 generates and outputs the current I_P2.

In some embodiments, the power conversion circuit 100 may further include a capacitor Cin, a capacitor Cout and a load Lo. The capacitor Cin includes a first terminal and a second terminal. The first terminal of the capacitor Cin is coupled to the positive terminal of the input voltage Vi. The second terminal of the capacitor Cin is coupled to the negative terminal of the input voltage Vi. The capacitor Cout includes a first terminal and a second terminal. The first terminal of the capacitor Cout is coupled to the positive terminal of the output terminal OT1 of the first resonant converter 110, the positive terminal of the output terminal OT2 of the second resonant converter 120 and the positive terminal of the output voltage Vo. The second terminal of the capacitor Cout is coupled to the negative terminal of the output terminal OT1 of the first resonant converter 110, the negative terminal of the output terminal OT2 of the second resonant converter 120 and the negative terminal of the output voltage Vo. The load Lo includes a first terminal and a second terminal. The first terminal of the load Lo is coupled to the positive terminal of the output terminal OT1 of the first resonant converter 110 and the positive terminal of the output terminal OT2 of the second resonant converter 120. The second terminal of the load Lo is coupled to the negative terminal of the output terminal OT1 of the first resonant converter 110 and the negative terminal of the output terminal OT2 of the second resonant converter 120. The first resonant converter 110 outputs the current I_P1, the second resonant converter 120 outputs the current I_P2, and the capacitor Cout may output the current ICout. The total output current Io includes the current I_P1, the current I_P2 and the current ICout flowing through the capacitor Cout, i.e., Io=I_P1+I_P2+ICout.

Furthermore, in some embodiments, when the switching signal CS1_P1 and the switching signal CS4_P1 are a high voltage level, the switching signal CS2_P1 and the switching signal CS3_P1 are a low voltage level. When the switching signal CS1_P1 and the switching signal CS4_P1 are the low voltage level, the switching signal CS2_P1 and the switching signal CS3_P1 are the high voltage level. That is, the switch QA_P1 and the switch QD_P1 may be turned on or turned off together, and the switch QB_P1 and the switch QC_P1 may be turned on or turned off together.

In addition, in some embodiments, when the switching signal CS1_P2 and the switching signal CS4_P2 are the high voltage level, the switching signal CS2_P2 and the switching signal CS3_P2 are the low voltage level. When the switching signal CS1_P2 and the switching signal CS4_P2 are the low voltage level, the switching signal CS2_P2 and the switching signal CS3_P2 are the high voltage. That is, the switch QA_P2 and the switch QD_P2 may be turned on or turned off together, and the switch QB_P2 and the switch QC_P2 may be turned on or turned off together.

In some embodiments, each of the switch QA_P1, the switch QB_P1, the switch QC_P1, the switch QD_P1, the switch QA_P2, the switch QB_P2, the switch QC_P2 and the switch QD_P2 may be a transistor. In other embodiments, each of the switch QA_P1, the switch QB_P1, the switch QC_P1, the switch QD_P1, the switch QA_P2, the switch QB_P2, the switch QC_P2 and the switch QD_P2 may include a transistor, a diode and a capacitor, and the coupling manner of the transistor, the diode and the capacitor is shown in FIG. 2, and the description thereof is not repeated herein.

The control device 300 is suitable for connecting and controlling the first resonant converter 110 and the second resonant converter 120 of the power conversion circuit 100 of FIG. 1 and FIG. 2. As shown in FIG. 3, the control device 300 may provide the plurality of first switching signals CS1_P1~CS4_P1 to the first bridge switching circuit 111, and provide the plurality of second switching signals CS1_P2~CS4_P2 to the second bridge switching circuit 121. The control device 300 may include a first control module 310, a second control module 320, and a third control module 330.

The first control module 310 may be coupled to the capacitor Cout of the power conversion circuit 100. The power conversion circuit 100 may include one or more sensors, which sense the total output current Io, the first current I1 flowing through the first resonant inductor Lr1 and the second current I2 flowing through the second resonant inductor Lr2. The first control module 310 may receive the output voltage Vo and the total output current Io of the power conversion circuit 100. Then, the first control module 310 may determine a switching frequency fs corresponding to the first switching signals CS1_P1~CS4_P1 and the second switching signals CS1_P2~CS4_P2 according to the output voltage Vo, the total output current Io, a predetermined voltage Vcmd and a predetermined current Icmd. In some embodiments, the predetermined voltage Vcmd and the predetermined current Icmd may be adjusted according to the requirements of the user.

In some embodiments, the first control module 310 may perform a subtraction calculation (i.e., Vcmd−Vo) on the predetermined voltage Vcmd and the output voltage Vo to obtain a first value. Then, the first control module 310 may perform the subtraction calculation (i.e., Icmd−Io) on the predetermined current Icmd and the total output current Io to obtain a second value. Afterwards, the first control module 310 may determine the switching frequency fs according to the first value and the second value.

Furthermore, the first control module 310 may compare the first value with the second value to determine whether the first value is less than the second value. When it is determined that the first value is less than the second value, the first control module 310 may determine the switching frequency fs according to the first value. When it is determined that the first value is not less than the second value (i.e., the second value is less than the first value), the first control module 310 may determine the switching frequency fs according to the second value. Therefore, by determining the switching frequency fs through the first control module 310, the switching frequencies of the first resonant converter 110 and the second resonant converter 120 of the power conversion circuit 100 may be made the same.

In some embodiments, the first control module 310 may include a first low-pass filter 311, a second low-pass filter 312, a first subtractor 313, a second subtractor 314, a first proportional integral (PI) controller 315, a second proportional integral controller 316, a first limiter 317, a second limiter 318 and a determination unit 319.

The first low-pass filter 311 includes an input terminal and an output terminal. The input terminal of the first low-pass filter 311 may receive the output voltage Vo. The output terminal of the first low-pass filter 311 may generate the output voltage Vo processed by the low-pass filtering. The second low-pass filter 312 includes an input terminal and an output terminal. The input terminal of the second low-pass filter 312 may receive the total output current Io. The output terminal of the second low-pass filter 312 may generate the total output current Io processed by the low-pass filtering.

The first subtractor 313 includes a first input terminal (such as the positive input terminal), a second input terminal (such as the negative input terminal) and an output terminal. The first input terminal of the subtractor 313 receives the predetermined voltage Vcmd. The second input terminal of the subtractor 313 is coupled to the output terminal of the first low-pass filter 311.

The second subtractor 314 includes a first input terminal (such as the positive input terminal), a second input terminal (such as the negative input terminal) and an output terminal. The first input terminal of the second subtractor 314 receives the predetermined current Icmd. The second input terminal of the second subtractor 314 is coupled to the output terminal of the second low-pass filter 312.

The first proportional integral controller 315 includes an input terminal and an output terminal. The input terminal of the first proportional integral controller 315 is coupled to the output terminal of the first subtractor 313. The second proportional integral controller 316 includes an input terminal and an output terminal. The input terminal of the second proportional integral controller 316 is coupled to the output terminal of the second subtractor 314. The first limiter 317 includes an input terminal and an output terminal. The input terminal of the first limiter 317 is coupled to the output terminal of the first proportional integral controller 315. The second limiter 318 includes an input terminal and an output terminal. The input terminal of the second limiter 318 is coupled to the output terminal of the second proportional integral controller 316. The determination unit 319 includes a first input terminal, a second input terminal, and an output terminal. The first input terminal of the determination unit 319 is coupled to the output terminal of the first limiter 317. The second input terminal of the determination unit 319 is coupled to the output terminal of the second limiter 318. The output terminal of the determination unit 319 outputs the switching frequency fs.

The second control module 320 may receive the first current I1 (as shown in FIG. 1 and FIG. 2) flowing through the first resonant inductor Lr1 and the second current I2 (as shown in FIG. 1 and FIG. 2) flowing through the second resonant inductor Lr2. For example, one or more sensors sense the first current I1 and the second current I2. Then, the second control module 320 may determine a phase shift angle PH corresponding to the first switching signals CS1_P1~CS4_P1 and the second switching signals CS1_P2~CS4_P2 according to the first current I1 flowing through the first resonant inductor Lr1 and the second current I2 flowing through the second resonant inductor Lr2.

In some embodiments, the second control module 320 may perform a subtraction calculation (i.e., I1−I2) on the first current I1 and the second current I2 to determine the above phase shift angle PH. For example, when the first current I1 is greater than the second current I2, the phase shift angle PH is a negative value. When the first current I1 is less than the second current I2, the phase shift angle PH is a positive value.

In some embodiments, the second control module 320 may include a first low-pass filter 321, a second low-pass filter 322, a subtractor 323, a proportional integral controller 324 and a limiter 325

The first low-pass filter 321 includes an input terminal and an output terminal. The input terminal of the first low-pass filter 321 may receive the first current I1. The second low-pass filter 322 includes an input terminal and an output terminal. The input terminal of the second low-pass filter 322 may receive the second current I2. The subtractor 323 includes a first input terminal (such as the positive input terminal), a second input terminal (such as the negative input terminal) and an output terminal. The first input terminal of the subtractor 323 is coupled to the output terminal of the first low-pass filter 321. The second input terminal of the subtractor 323 is coupled to the output terminal of the second low-pass filter 322. The proportional integral controller 324 includes an input terminal and an output terminal. The input terminal of the proportional integral controller 324 is coupled to the output terminal of the subtractor 323. The limiter 325 includes an input terminal and an output terminal. The input terminal of the limiter 325 is coupled to the output terminal of the proportional integral controller 324. The output terminal of the limiter 325 outputs the phase shift angle PH.

The third control module 330 may be coupled to the first control module 310, the second control module 320, the first bridge switching circuit 111 and the second bridge switching circuit 121. For example, the third control module 330 may be coupled to the switches QA_1~QD_P2 of the first bridge switching circuit 111 and the second bridge switching circuit 121. The third control module 330 may generate the first switching signals CS1_P1~CS4_P1 and the second switching signals CS1_P2~CS4_P2 according to the switching frequency fs and the phase shift angle PH. In some embodiments, the phase shift angle PH may correspond to a first equivalent duty cycle Deff1 or a second equivalent duty cycle Deff2. For example, when the phase shift angle PH is zero, the first equivalent duty cycle Deff1 or the second equivalent duty cycle Deff2 is 50%. When the phase shift angle PH increases, the first equivalent duty cycle Deff1 or the second equivalent duty cycle Deff2 decreases.

In some embodiments, when the first current I1 is greater than the second current I2, the phase shift angle PH output by the second control module 320 is a negative value. Then, the third control module 330 may generate the corresponding first switching signals CS1_P1~CS4_P1 and the corresponding second switching signals CS1_P2~CS4_P2 according to the switching frequency fs and the phase shift angle PH that is the negative value. For example, the third control module 330 may decrease the first equivalent duty cycle Deff1 of the first switching signals CS1_P1~CS4_P1 corresponding to the switches QA_P1~QD_P1 of the power conversion circuit 100 (i.e., the first equivalent duty cycle Deff1 is less than 50%), and the third control module 330 may maintain the second equivalent duty cycle Deff2 of the second switching signals CS1_P2 . . . CS4_P2 corresponding to switches QA_P2~QD_P2 of the power conversion circuit 100 at 50%.

In some embodiments, when the first current I1 is less than the second current I2, the phase shift angle PH output by the second control module 320 is a positive value. Then, the third control module 330 may generate the corresponding first switching signals CS1_P1~CS4_P1 and the corresponding second switching signals CS1_P2~CS4_P2 according to the switching frequency fs and the phase shift angle PH that is the positive value. For example, the third control module 330 may decrease the second equivalent duty cycle Deff2 of the second switching signals CS1_P2~CS4_P2 corresponding to the switches QA_P2~QD_P2 of the power conversion circuit 100 (i.e., the second equivalent duty cycle Deff2 is less than 50%), and the third control module 330 may maintain the first equivalent duty cycle Deff1 of the first switching signals CS1_P1~CS4_P1 corresponding to switches QA_P1~QD_P1 of the power conversion circuit 100 at 50%.

In addition, the third control module 330 may control the interleaved phase angle between the first switching signals CS1_P1~CS4_P1 and the second switching signals CS1_P2~CS4_P2 according to the switching frequency fs and a resonant frequency. In the embodiment, the above resonant frequency may be calculated, for example, from the first resonant capacitor Cr1 and the first resonant inductor Lr1 or the second resonant capacitor Cr2 and the second resonant inductor Lr2 of the power conversion circuit 100. For example, the resonant frequency may be

$$\frac{1}{2 π \sqrt{Lr 1 \times Cr 1}} ,$$

or the resonant frequency may be

$$\frac{1}{2 π \sqrt{Lr 2 \times Cr 2}} .$$

In some embodiments, the inductance value of the first resonant inductor Lr1 is the same as the inductance value of the second resonant inductor Lr2, and the capacitance value of the first resonant capacitor Cr1 is the same as the capacitance value of the second resonant capacitor Cr2. Therefore, the resonant frequency may be

$$1 / ( 2 π \sqrt{Lr 1 \times Cr 1} ) = \frac{1}{2 π \sqrt{Lr 2 \times Cr 2}} .$$

Furthermore, the third control module 330 may determine whether the switching frequency fs is greater than or equal to the resonant frequency. When it is determined that the switching frequency fs is greater than or equal to the resonant frequency, the third control module 330 controls that the above interleaved phase angle is an equivalent switch turn-off interleaved phase angle of the first switching signals CS1_P1 . . . CS4_P1 and the second switching signals CS1_P2 . . . CS4_P2. In addition, the above equivalent switch turn-off interleaved phase angle may be 90 degrees. For example, the third control module 330 may at least stagger the phases of the first switching signal CS4_P1 and the second switching signal CS4_P2 corresponding to the switches QD_P1 and QD_P2 of the power conversion circuit 100 from the high voltage level to the low voltage level by 90 degrees. Therefore, it may be ensured that the phases of the current I_P1 and the current I_P2 of the power conversion circuit 100 are staggered by 90 degrees, and the area of the current overlapping is minimum, so that the ripple of the current ICout is smaller.

When it is determined that the switching frequency fs is not greater than or equal to (i.e., less than) the resonant frequency, the third control module 330 controls that the above interleaved phase angle is an equivalent switch turn-on interleaved phase angle of the first switching signals CS1_P1 . . . CS4_P1 and the second switching signals CS1_P2 . . . CS4_P2. In addition, the above equivalent switch turn-on interleaved phase angle may be 90 degrees. For example, the third control module 330 may at least stagger the phases of the first switching signals CS1_P1 and the second switching signals CS1_P2 corresponding to the switches QA_P1 and QA_P2 of the power conversion circuit 100 from the low voltage level to the high voltage level by 90 degrees. Therefore, it may be ensured that the phases of the current I_P1 and the current I_P2 of the power conversion circuit 100 are staggered by 90 degrees, and the area of the current overlapping is minimum, so that the ripple of the current ICout is smaller.

In some embodiments, the third control module 330 may include an adder 331, a subtractor 332, a first limiter 333, a second limiter 334 and a switching signal generating circuit 335.

The adder 331 includes a first input terminal (such as the positive input terminal), a second input terminal (such as the positive input terminal) and an output terminal. The first input terminal of the adder 331 receives the phase shift angle PH. The second input terminal of the adder 331 receives a predetermined phase shift angle. The subtractor 332 includes a first input terminal (such as the positive input terminal), a second input terminal (such as the negative input terminal) and an output terminal. The first input terminal of the subtractor 332 receives the predetermined phase shift angle. The second input terminal of the subtractor 332 receives the phase shift angle PH.

The first limiter 333 includes an input terminal and an output terminal. The input terminal of the first limiter 333 is coupled to the output terminal of the adder 331. The output terminal of the first limiter 333 outputs the first equivalent duty cycle Deff1. The second limiter 334 includes an input terminal and an output terminal. The input terminal of the second limiter 334 is coupled to the output terminal of the subtractor 332. The output terminal of the second limiter 334 outputs the second equivalent duty cycle Deff2. The switching signal generating circuit 335 is coupled to the first control module 310, the output terminal of the first limiter 333 and the output terminal of the second limiter 334. The switching signal generating circuit 335 receives the switching frequency fs, the first equivalent duty cycle Deff1 and the second equivalent duty cycle Deff2. The switching signal generating circuit 335 may generate the first switching signals CS1_P1~CS4_P1 according to the switching frequency fs and the first equivalent duty cycle Deff1, and the switching signal generating circuit 335 may generate the second switching signals CS1_P2~CS4_P2 according to the switching frequency fs and the second equivalent duty cycle Deff2 and control the interleaved phase angle.

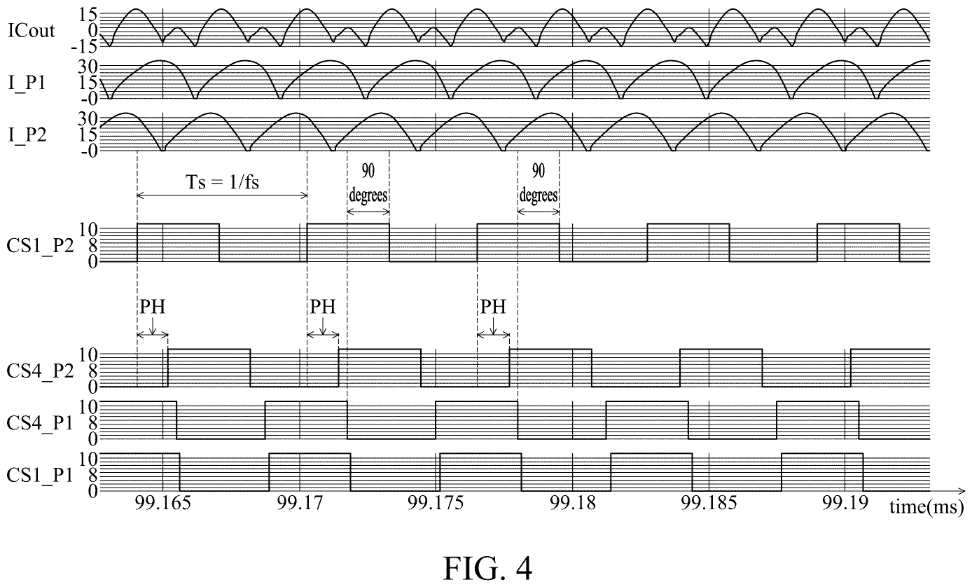

FIG. 4 is a waveform diagram of a current ICout, a current I_P1, a current I_P2, a switching signal CS1_P1, a switching signal CS4_P1, a switching signal CS1_P2 and a switching signal CS4_P2 when a switching frequency is greater than or equal to a resonant frequency according to an embodiment of the disclosure. In FIG. 4, the reference number “Ts” is a switching period, and the switching period Ts is 1/the switching frequency fs (i.e., Ts=1/fs). As can be seen in FIG. 4, there is a phase shift angle PH between the second switching signals CS1_P2 and CS4_P2. Therefore, in the example of FIG. 4, the second equivalent duty cycle Deff2 is less than 50%. In addition, as can be seen in FIG. 4, the interleaved phase angle is the equivalent switch turn-off interleaved phase angle of the first switching signal CS4_P1 and the second switching signal CS1_P2, and the equivalent switch turn-off interleaved phase angle is 90 degrees, which may ensure that the phases of the current I_P1 and the current I_P2 are staggered by 90 degrees, so that the ripple of the current ICout is smaller, i.e., the current ICout is about 9.7 Arms.

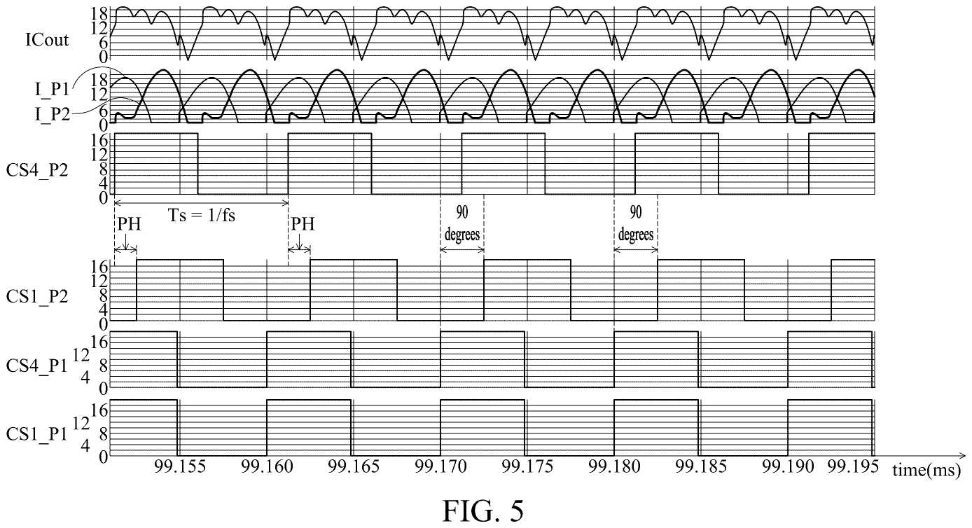

FIG. 5 is a waveform diagram of a current ICout, a current I_P1, a current I_P2, a switching signal CS1_P1, a switching signal CS4_P1, a switching signal CS1_P2 and a switching signal CS4_P2 when a switching frequency less than to a resonant frequency according to an embodiment of the disclosure. In FIG. 5, the reference number “T” is a switching period, and the switching period Ts is 1/the switching frequency fs (i.e., Ts=1/fs). As can be seen in FIG. 5, there is a phase shift angle PH between the second switching signals CS1_P2 and CS4_P2. Therefore, in the example of FIG. 5, the second equivalent duty cycle Deff2 is less than 50%. In addition, as can be seen in FIG. 5, the interleaved phase angle is the equivalent switch turn-on interleaved phase angle of the first switching signal CS1_P1 and the second switching signal CS1_P2, and the equivalent switch turn-on interleaved phase angle is 90 degrees, which may ensure that the phases of the current I_P1 and the current I_P2 are staggered by 90 degrees, so that the ripple of the current ICout is smaller, i.e., the current ICout is about 2 Arms.

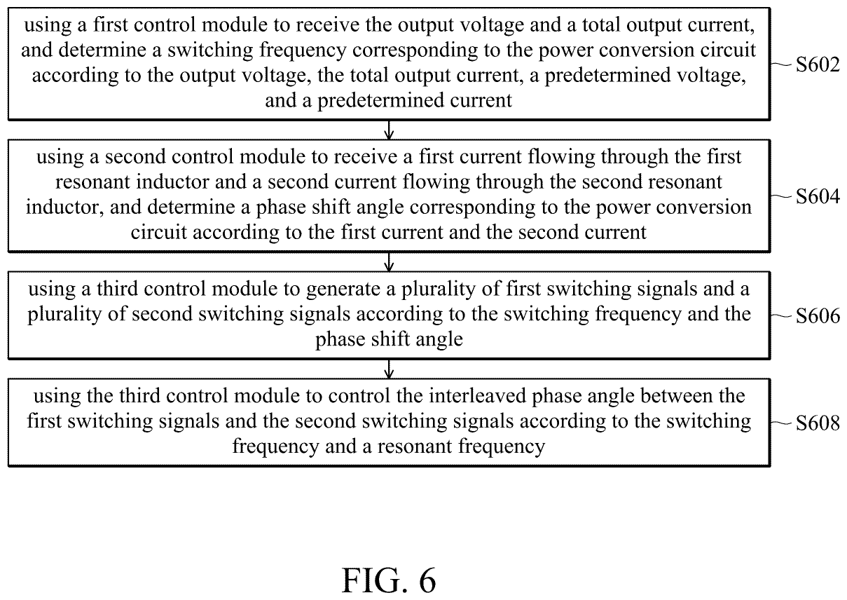

FIG. 6 is a flowchart of an operation method of a power conversion circuit according to an embodiment of the disclosure. The operation method of the power conversion circuit of the embodiment is suitable for the power conversion circuit 100 of FIG. 1 and FIG. 2 and the control device 300 shown in FIG. 3. In step S602, the method involves using a first control module to receive the output voltage and a total output current, and determine a switching frequency corresponding to the power conversion circuit according to the output voltage, the total output current, a predetermined voltage and a predetermined current.

In step S604, the method involves using a second control module to receive a first current flowing through the first resonant inductor and a second current flowing through the second resonant inductor, and determine a phase shift angle corresponding to the power conversion circuit according to the first current and the second current. Furthermore, step S604 may include using the second control module to perform a subtraction calculation on the first current and the second current to determine the phase shift angle corresponding to the power conversion circuit.

In step S606, the method involves using a third control module to generate a plurality of first switching signals and a plurality of second switching signals according to the switching frequency and the phase shift angle. In step S608, the method involves using the third control module to control the interleaved phase angle between the first switching signals and the second switching signals according to the switching frequency and a resonant frequency. In some embodiments, when the switching frequency is greater than or equal to the resonant frequency, the interleaved phase angle is an equivalent switch turn-off interleaved phase angle of the first switching signals and the second switching signals. In addition, the above equivalent switch turn-off interleaved phase angle is 90 degrees. In some embodiments, when the switching frequency is less than the resonant frequency, the interleaved phase angle is an equivalent switch turn-on interleaved phase angle of the first switching signals and the second switching signals. In addition, the above equivalent switch turn-on interleaved phase angle is 90 degrees.

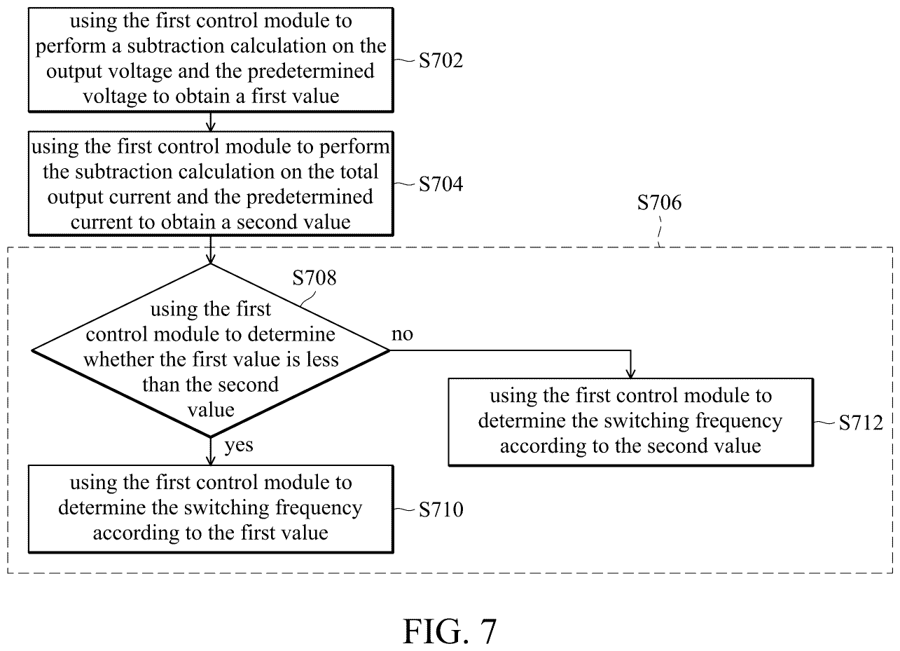

FIG. 7 is a detailed flowchart of step S602 in FIG. 6. In step S702, the method involves using the first control module to perform a subtraction calculation on the output voltage and the predetermined voltage to obtain a first value. In step S704, the method involves using the first control module to perform the subtraction calculation on the total output current and the predetermined current to obtain a second value. In step S706, the method involves using the first control module to determine the switching frequency according to the first value and the second value. Furthermore, step S706 may further include step S708, step S710 and step S712.

In step S708, the method involves using the first control module to determine whether the first value is less than the second value. When it is determined that the first value is less than the second value, the method performs step S710. In step S710, the method involves using the first control module to determine the switching frequency according to the first value. When it is determined that the first value is not less than the second value, the method performs step S712. In step S712, the method involves using the first control module to determine the switching frequency according to the second value.

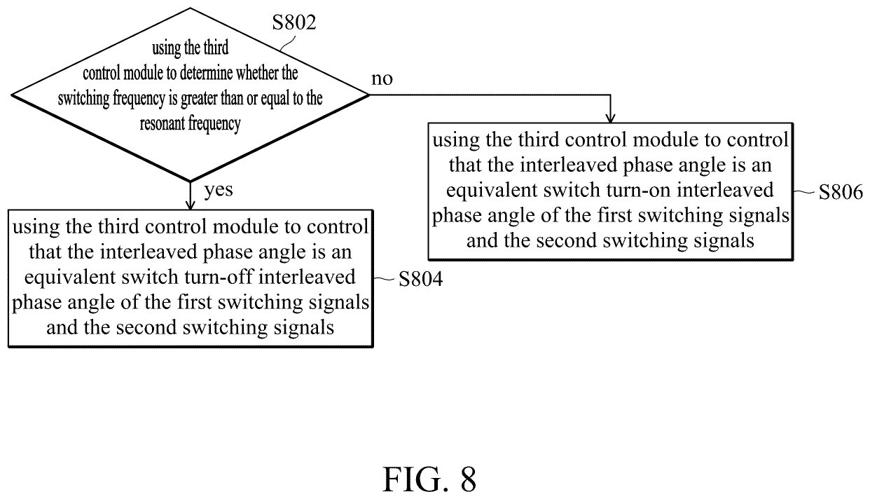

FIG. 8 is a detailed flowchart of step S608 in FIG. 6. In step S802, the method involves using the third control module to determine whether the switching frequency is greater than or equal to the resonant frequency. When it is determined that the switching frequency is greater than or equal to the resonant frequency, the method performs step S804. In step S804, the method involves using the third control module to control that the interleaved phase angle is an equivalent switch turn-off interleaved phase angle of the first switching signals and the second switching signals. The above equivalent switch turn-off interleaved phase angle may be 90 degrees. When it is determined that the switching frequency is not greater than or equal to (i.e., less than) the resonant frequency, the method performs step S806. In step S806, the method involves using the third control module to control that the interleaved phase angle is an equivalent switch turn-on interleaved phase angle of the first switching signals and the second switching signals. The above equivalent switch turn-on interleaved phase angle may be 90 degrees.

In some embodiments, the power conversion circuit 100 may further include a third resonant converter. The circuit structure of the third resonant converter is the same as that of the first resonant converter 110 and the second resonant converter 120, and the third resonant converter is connected in parallel with the first resonant converter 110 and the second resonant converter 120. In the embodiment, the equivalent switch turn-off or turn-on interleaved phase angle may be 60 degrees. In some embodiments, the power conversion circuit 100 may include N resonant converters and the N resonant converters are connected in parallel, and the equivalent switch turn-off or turn-on interleaved phase angle may be (180/N) degrees.

It should be noted that the order of steps in FIG. 6, FIG. 7 and FIG. 8 is only for illustrative purposes, and is not intended to limit the order of steps of the disclosure. The user may change the order of the steps above according the requirement thereof. The flowcharts described above may add additional steps or use fewer steps without departing from the spirit and scope of the disclosure.

In summary, according to the power conversion circuit and the operation method thereof disclosed by the embodiment of the disclosure, the first control module receives the output voltage and the total output current, and determines the switching frequency corresponding to the power conversion circuit according to the output voltage, the total output current, the predetermined voltage and the predetermined current. The second control module determines the phase shift angle corresponding to the power conversion circuit according to the first current flowing through the first resonant inductor and the second current flowing through the second resonant inductor. The third control module generates the first switching signals and the second switching signals according to the switching frequency and the phase shift angle, and controls the interleaved phase angle between the first switching signals and the second switching signals according to the switching frequency and the resonant frequency. Therefore, the current of the power conversion circuit may be effectively balanced, and current ripple of the power conversion circuit may be reduced, thereby reducing the number of input and output capacitors.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power conversion circuit, comprising:
a first resonant converter, comprising a first transformer, a first resonant inductor, a first resonant capacitor, a first bridge switching circuit and a first rectifier circuit, wherein the first transformer comprises a first primary winding and a first secondary winding, the first resonant inductor and the first resonant capacitor are connected in series and connected to the first primary winding, the first bridge switching circuit is connected to the first resonant inductor, the first resonant capacitor and the first primary winding, and the first secondary winding is connected to the first rectifier circuit;
a second resonant converter, comprising a second transformer, a second resonant inductor, a second resonant capacitor, a second bridge switching circuit and a second rectifier circuit, wherein the second transformer comprises a second primary winding and a second secondary winding, the second resonant inductor and the second resonant capacitor are connected in series and connected to the second primary winding, the second bridge switching circuit is connected to the second resonant inductor, the second resonant capacitor and the second primary winding, and the second secondary winding is connected to the second rectifier circuit; wherein the first bridge switching circuit and the second bridge switching circuit receive an input voltage, an output terminal of the first rectifier circuit and an output terminal of the second rectifier circuit are connected in parallel, and the first rectifier circuit and the second rectifier circuit output an output voltage; and
a control device, configured to provide a plurality of first switching signals to the first bridge switching circuit and provide a plurality of second switching signals to the second bridge switching circuit, wherein the control device comprises:
a first control module, configured to determine a switching frequency corresponding to the plurality of first switching signals and the plurality of second switching signals according to the output voltage, a total output current, a predetermined voltage and a predetermined current;
a second control module, configured to determine a phase shift angle corresponding to the plurality of first switching signals and the plurality of second switching signals according to a first current flowing through the first resonant inductor and a second current flowing through the second resonant inductor; and
a third control module, configured to generate the plurality of first switching signals and the plurality of second switching signals according to the switching frequency and the phase shift angle, and to control an interleaved phase angle between the plurality of first switching signals and the plurality of second switching signals according to the switching frequency and a resonant frequency.

2. The power conversion circuit as claimed in claim 1, wherein when the switching frequency is greater than or equal to the resonant frequency, the interleaved phase angle is an equivalent switch turn-off interleaved phase angle of the plurality of first switching signals and the plurality of second switching signals.

3. The power conversion circuit as claimed in claim 2, wherein the equivalent switch turn-off interleaved phase angle is 90 degrees.

4. The power conversion circuit as claimed in claim 1, wherein when the switching frequency is less than the resonant frequency, the interleaved phase angle is an equivalent switch turn-on interleaved phase angle of the plurality of first switching signals and the plurality of second switching signals.

5. The power conversion circuit as claimed in claim 4, wherein the equivalent switch turn-on interleaved phase angle is 90 degrees.

6. The power conversion circuit as claimed in claim 1, wherein each of the first bridge switching circuit and the first rectifier circuit is a full-bridge switching circuit.

7. The power conversion circuit as claimed in claim 1, wherein the third control module comprises:
an adder, comprising a first input terminal, a second input terminal and an output terminal, wherein the first input terminal of the adder is configured to receive the phase shift angle, and the second input terminal of the adder is configured to receive a predetermined phase shift angle;
a subtractor, comprising a first input terminal, a second input terminal and an output terminal, wherein the first input terminal of the subtractor is configured to receive the predetermined phase shift angle, and the second input terminal of the subtractor is configured to receive the phase shift angle;
a first limiter, comprising an input terminal and an output terminal, wherein the input terminal of the first limiter is coupled to the output terminal of the adder, and the output terminal of the first limiter is configured to output a first equivalent duty cycle;
a second limiter, comprising an input terminal and an output terminal, wherein the input terminal of the second limiter is coupled to the output terminal of the subtractor, and the output terminal of the second limiter is configured to output a second equivalent duty cycle; and
a switching signal generating circuit, coupled to the first control module, the output terminal of the first limiter and the output terminal of the second limiter and configured to receive the switching frequency, the first equivalent duty cycle and the second equivalent duty cycle, wherein the switching signal generating circuit is configured to generate the plurality of first switching signals according to the switching frequency and the first equivalent duty cycle, and the switching signal generating circuit is configured to generate the plurality of second switching signals according to the switching frequency and the second equivalent duty cycle and control the interleaved phase angle.

8. The power conversion circuit claimed in claim 1, wherein the first control module is configured to perform a subtraction calculation on the output voltage and the predetermined voltage to obtain a first value, the first control module is configured to perform the subtraction calculation on the total output current and the predetermined current to obtain a second value, and the first control module is configured to determine the switching frequency according to the first value and the second value.

9. The power conversion circuit as claimed in claim 8, wherein the first control module is configured to determine whether the first value is less than the second value, when determining that the first value is less than the second value, the first control module is configured to determine the switching frequency according to the first value, and when determining that the first value is not less than the second value, the first control module is configured to determine the switching frequency according to the second value.

10. The power conversion circuit in claim 1, wherein the first control module comprises:
a first low-pass filter, comprising an input terminal and an output terminal, wherein the input terminal of the first low-pass filter is configured to receive the output voltage;
a second low-pass filter, comprising an input terminal and an output terminal, wherein the input terminal of the second low-pass filter is configured to receive the total output current;
a first subtractor, comprising a first input terminal, a second input terminal and an output terminal, wherein the first input terminal of the subtractor is configured to receive the predetermined voltage, and the second input terminal of the subtractor is coupled to the output terminal of the first low-pass filter;
a second subtractor, comprising a first input terminal, a second input terminal and an output terminal, wherein the first input terminal of the second subtractor is configured to receive the predetermined current, and the second input terminal of the second subtractor is coupled to the output terminal of the second low-pass filter;
a first proportional integral controller, comprising an input terminal and an output terminal, wherein the input terminal of the first proportional integral controller is coupled to the output terminal of the first subtractor;
a second proportional integral controller, comprising an input terminal and an output terminal, wherein the input terminal of the second proportional integral controller is coupled to the output terminal of the second subtractor;
a first limiter, comprising an input terminal and an output terminal, wherein the input terminal of the first limiter is coupled to the output terminal of the first proportional integral controller;
a second limiter, comprising an input terminal and an output terminal, wherein the input terminal of the second limiter is coupled to the output terminal of the second proportional integral controller; and
a determination unit, comprising a first input terminal, a second input terminal and an output terminal, wherein the first input terminal of the determination unit is coupled to the output terminal of the first limiter, the second input terminal of the determination unit is coupled to the output terminal of the second limiter, and the output terminal of the determination unit is configured to output the switching frequency.

11. The power conversion circuit as claimed in claim 1, wherein the second control module is configured to perform a subtraction calculation on the first current and the second current to determine the phase shift angle.

12. The power conversion circuit as claimed in claim 1, wherein the second control module comprises:
a first low-pass filter, comprising an input terminal and an output terminal, wherein the input terminal of the first low-pass filter is configured to receive the first current;
a second low-pass filter, comprising an input terminal and an output terminal, wherein the input terminal of the second low-pass filter is configured to receive the second current;
a subtractor, comprising a first input terminal, a second input terminal and an output terminal, wherein the first input terminal of the subtractor is coupled to the output terminal of the first low-pass filter, and the second input terminal of the subtractor is coupled to the output terminal of the second low-pass filter;
a proportional integral controller, comprising an input terminal and an output terminal, wherein the input terminal of the proportional integral controller is coupled to the output terminal of the subtractor;
a limiter, comprising an input terminal and an output terminal, wherein the input terminal of the limiter is coupled to the output terminal of the proportional integral controller, and the output terminal of the limiter is configured to output the phase shift angle.

13. An operation method of a power conversion circuit, wherein the power conversion circuit comprises a first resonant converter and a second resonant converter, the first resonant converter comprises a first transformer, a first resonant inductor, a first resonant capacitor, a first bridge switching circuit and a first rectifier circuit, the first transformer comprises a first primary winding and a first secondary winding, the first resonant inductor and the first resonant capacitor are connected in series and connected to the first primary winding, the first bridge switching circuit is connected to the first resonant inductor, the first resonant capacitor and the first primary winding, the first secondary winding is connected to the first rectifier circuit, the second resonant converter comprises a second transformer, a second resonant inductor, a second resonant capacitor, a second bridge switching circuit and a second rectifier circuit, the second transformer comprises a second primary winding and a second secondary winding, the second resonant inductor and the second resonant capacitor are connected in series and connected to the second primary winding, the second bridge switching circuit is connected to the second resonant inductor, the second resonant capacitor and the second primary winding, and the second secondary winding is connected to the second rectifier circuit; wherein the first bridge switching circuit and the second bridge switching circuit receive an input voltage, an output terminal of the first rectifier circuit and an output terminal of the second rectifier circuit are connected in parallel, the first rectifier circuit and the second rectifier circuit output an output voltage, and the operation method comprises:
using a first control module to receive the output voltage and a total output current, and determine a switching frequency corresponding to the power conversion circuit according to the output voltage, the total output current, a predetermined voltage and a predetermined current;
using a second control module to receive a first current flowing through the first resonant inductor and a second current flowing through the second resonant inductor, and determine a phase shift angle corresponding to the power conversion circuit according to the first current and the second current;
using a third control module to generate a plurality of first switching signals and a plurality of second switching signals according to the switching frequency and the phase shift angle; and
using the third control module to control an interleaved phase angle between the plurality of first switching signals and the plurality of second switching signals according to the switching frequency and a resonant frequency.

14. The operation method of the power conversion circuit as claimed in claim 13, wherein when the switching frequency is greater than or equal to the resonant frequency, the interleaved phase angle is an equivalent switch turn-off interleaved phase angle of the plurality of first switching signals and the plurality of second switching signals.

15. The operation method of the power conversion circuit as claimed in claim 14, wherein the equivalent switch turn-off interleaved phase angle is 90 degrees.

16. The operation method of the power conversion circuit as claimed in claim 13, wherein when the switching frequency is less than the resonant frequency, the interleaved phase angle is an equivalent switch turn-on interleaved phase angle of the plurality of first switching signals and the plurality of second switching signals.

17. The operation method of the power conversion circuit as claimed in claim 16, wherein the equivalent switch turn-on interleaved phase angle is 90 degrees.

18. The operation method of the power conversion circuit as claimed in claim 13, wherein the step of determining the switching frequency corresponding to the power conversion circuit according to the output voltage, the total output current, the predetermined voltage and the predetermined current comprises:
using the first control module to perform a subtraction calculation on the output voltage and the predetermined voltage to obtain a first value;
using the first control module to perform the subtraction calculation on the total output current and the predetermined current to obtain a second value; and
using the first control module to determine the switching frequency according to the first value and the second value.

19. The operation method of the power conversion circuit as claimed in claim 18, wherein the step of using the first control module to determine the switching frequency according to the first value and the second value comprises:
using the first control module to determine whether the first value is less than the second value;
when determining that the first value is less than the second value, using the first control module to determine the switching frequency according to the first value; and
when determining that the first value is not less than the second value, using the first control module to determine the switching frequency according to the second value.

20. The operation method of the power conversion circuit as claimed in claim 13, wherein the step of determining the phase shift angle corresponding to the power conversion circuit according to the first current and the second current comprises:
using the second control module to perform a subtraction calculation on the first current and the second current to determine the phase shift angle.
